(19) United States
(12) Patent Application Publication
(10) Pub. No.: US 2016/0004397 A1
(43) Pub. Date: Jan. 7, 2016

(54) MOBILE TERMINAL AND CONTROLLING METHOD THEREOF

(71) Applicant: LG ELECTRONICS INC., Seoul (KR)

(72) Inventors: Mina KIM, Seoul (KR); Taejun KIM, Seoul (KR); Hosung SONG, Seoul (KR); Jinkyu PARK, Seoul (KR)

(73) Assignee: LG ELECTRONICS INC., Seoul (KR)

(21) Appl. No.: 14/572,508

(22) Filed: Dec. 16, 2014

(30) Foreign Application Priority Data
Jul. 3, 2014 (KR) 10-2014-0083279

(51) Int. Cl. G06F 3/0483; G10L 15/26; G06F 3/16

(52) U.S. Cl. CPC G06F 3/0483; G06F 3/165; G10L 15/26; H04W 88/02

(57) ABSTRACT

According to a mobile terminal disclosed in the present invention includes a memory for storing an e-book content, a wireless communication unit for transmitting the e-book content to an external server, a display unit for outputting the e-book content, and a controller configured to cause the wireless communication unit to transmit at least partial content of the e-book to at least the external server or the second terminal, cause the display to display a first notification notifying that the e-book or the at least partial content of the e-book is activated in the second terminal, cause the display to display content of the e-book in response to an input received in response to the displayed notification, and cause output or display of at least an image, an audio, or a text received from the second terminal in which the e-book is activated via the audio output unit or the display.

### CROSS-REFERENCE TO RELATED APPLICATIONS

Pursuant to 35 U.S.C. §119(a), this application claims the benefit of earlier filing date and right of priority to Korean Application No. 10-2014-0083279, filed on Jul. 3, 2014, the contents of which are hereby incorporated by reference herein in its entirety.

### BACKGROUND OF THE INVENTION

1. Field of the Invention

The present invention relates to a mobile terminal, and more particularly, to a mobile terminal and controlling method thereof. Although the present invention is suitable for a wide scope of applications, it is particularly suitable for recommending an e-book content to a prescribed terminal and then interacting with a user of the prescribed terminal currently appreciating the e-book content.

2. Discussion of the Related Art

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

Efforts are ongoing to support and increase the functionality of mobile terminals. Such efforts include software and hardware improvements, as well as changes and improvements in the structural components.

Recently, a mobile terminal is increasingly used as a device for appreciating e-book contents. When an e-book content is activated in a mobile terminal, it is advantageous in reading a book more stereoscopically than reading a conventional paper book. For instance, a user can appreciate various images and music materials in association with a book content through such a file attached to an e-book content as a music file, a video file and the like.

Thus, since an e-book content can be utilized together with image and/or music materials, it is increasingly utilized for children's education. Yet, since a child has low concentration on reading a book, the child has difficulty in reading a book for a long time, parental guidance or direction is frequently required.

Therefore, the present invention intends to disclose a mobile terminal for monitoring a book reading activity of a child when a parent is located in a remote place.

### SUMMARY OF THE INVENTION

Accordingly, embodiments of the present invention are directed to a mobile terminal and controlling method thereof that substantially obviate one or more problems due to limitations and disadvantages of the related art.

An object of the present invention is to provide a mobile terminal and controlling method thereof, by which user's convenience can be further enhanced.

In particular, one object of the present invention is to provide a mobile terminal and controlling method thereof, by which an e-book content appropriate for a prescribed terminal user can be recommended.

Another object of the present invention is to provide a mobile terminal and controlling method thereof, by which interaction with a prescribed terminal user currently appreciating an e-book content can be performed.

Additional advantages, objects, and features of the invention will be set forth in the disclosure herein as well as the accompanying drawings. Such aspects may also be appreciated by those skilled in the art based on the disclosure herein.

To achieve these objects and other advantages and in accordance with the purpose of the invention, as embodied and broadly described herein, a mobile terminal according to one embodiment of the present invention may include a memory configured to store an e-book content, a wireless communication unit configured to transmit the e-book content to an external server, a display unit configured to output the e-book content, and a controller, after the e-book content has been transmitted to the external server, if the e-book content is activated in a specific terminal having downloaded the e-book content, the controller controlling an indication to be outputted to indicate that the e-book content has been activated in the specific terminal, the controller controlling at least one of an image, an audio and a text to be received from the different terminal currently activating the e-book content, the controller controlling the received at least one to be displayed via the display unit.

In another aspect of the present invention, a method of controlling a mobile terminal according to another embodiment of the present invention may include the steps of uploading an e-book content to an external server, if the e-book content is activated in a specific terminal having downloaded the e-book content from the external server, outputting an indication indicating that the e-book content has been activated in the specific terminal, receiving at least one of an image, an audio and a text from the different terminal currently activating the e-book content, and displaying the received at least one.

Effects obtainable from the present invention may be non-limited by the above mentioned effect. And, other unmentioned effects can be clearly understood from the following description by those having ordinary skill in the technical field to which the present invention pertains.

It is to be understood that both the foregoing general description and the following detailed description of the present invention are exemplary and explanatory and are intended to provide further explanation of the invention as claimed.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIG. 1A is a block diagram of a mobile terminal in accordance with the present disclosure;

FIGS. 1B and 1C are conceptual views of one example of the mobile terminal, viewed from different directions;

FIG. 2 is a flowchart for operations of a first mobile terminal and a second mobile terminal according to the present invention;

FIGS. 3A and 3B are diagrams of a user interface displayed on recording a narration;

FIGS. 4A and 4B are diagrams for one example of a user interface provided to determine whether a first terminal having received an indication information to monitor a second terminal;

FIGS. 5A, 5B and 5C are diagrams for one example of outputting an indicator indicating that an e-book content is activated in a second terminal;

FIGS. 6A and 6B are diagrams for one example of a user interface outputting the same page of a second terminal;

FIGS. 7A, 7B and 7C are diagrams for one example of an output of a user interface including image data;

FIGS. 8A, 8B and 8C are diagrams for one example of an output of a user interface including text data;

FIGS. 9A, 9B, 9C and 9D are diagrams for one example of an output of a user interface including emotional state information;

FIGS. 10A and 10B are diagrams for one example of an output of a user interface including voice-reading capability information;

FIGS. 11A, 11B, 11C, 11D and 11E are diagrams of a user interface provided to a second terminal to input a question and a user interface provided to a first terminal receiving an input of a question, respectively;

FIGS. 12A, 12B, 12C and 12D are diagrams for examples of displaying an indicator indicating that a question is received from a second terminal; and

FIGS. 13A, 13B, and 13C are diagrams for one example of outputting an indicator indicating that appreciation of an e-book content is ended in a second terminal.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

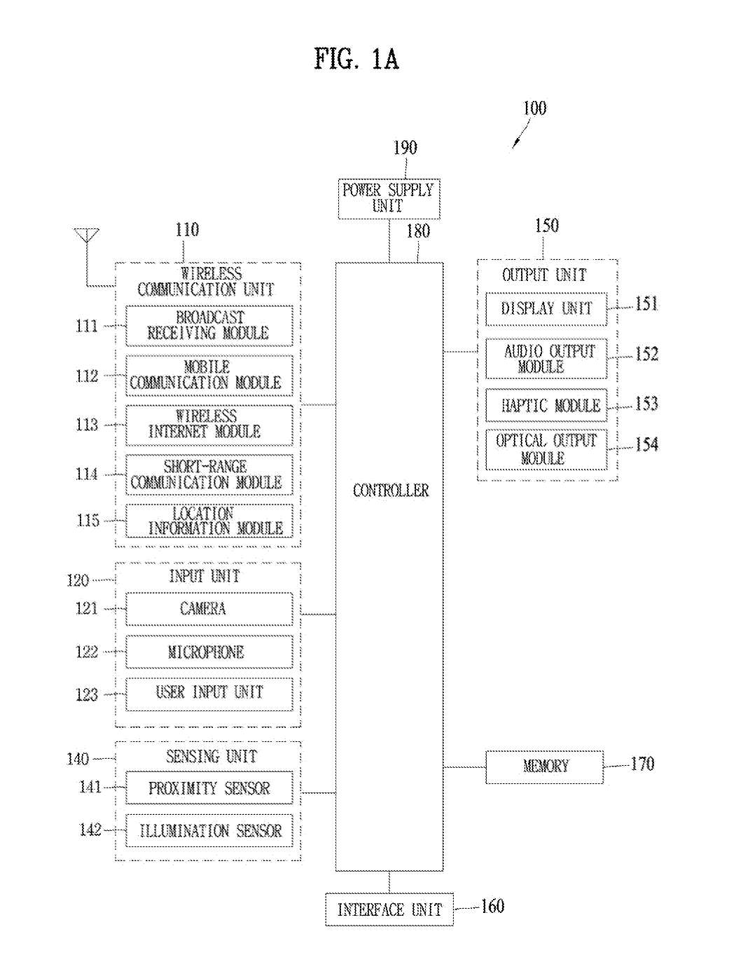

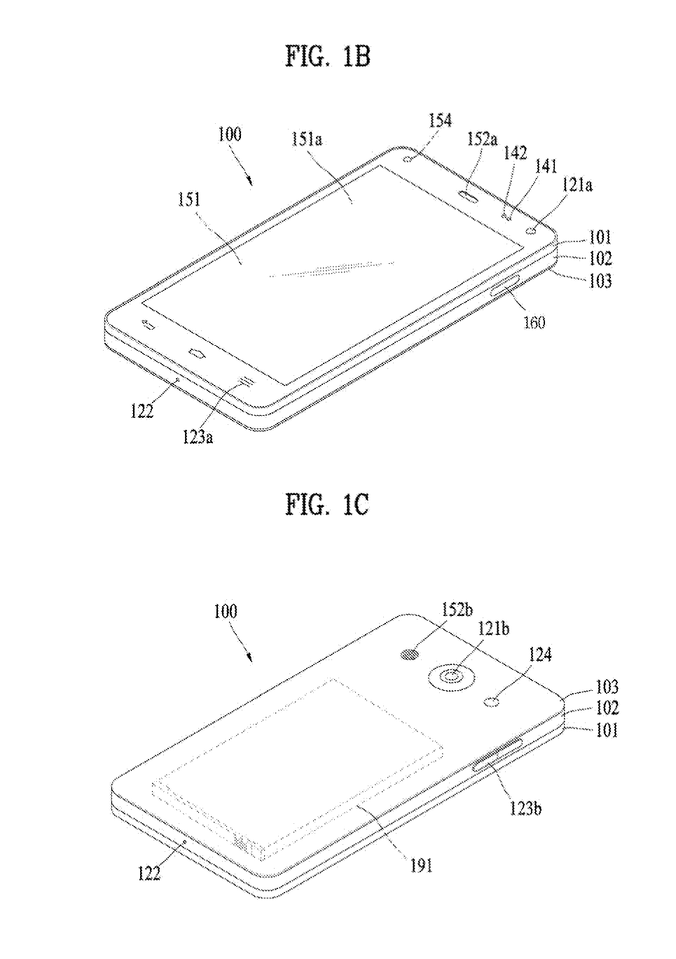

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

The mobile terminal 100 can play a role as a content recommender in recommending a content to be consumed by a different terminal as well as a role as a content provider in providing a content to the different terminal Generally, the mobile terminal 100 can recommend a content, which is to be consumed by a different terminal, to the different terminal through an email, an instant message, a text message, a messenger, a push message or the like. For instance, the mobile terminal sends a message, in which a URL (uniform resource locator) address capable of accessing a specific content is contained, to a different terminal. If so, the different terminal can appreciate the content recommended by the mobile terminal through an access using the RIL address.

Yet, the above-mentioned method causes the following problems. First of all, it is inconvenient for the mobile terminal 100 to acquire a URL address, which is to be provided to a different terminal, for accessing a content. Secondly, the different terminal is unable to confirm the validity of a received URL.

Therefore, the present invention intends to provide a new method for the mobile terminal 100 to recommend a content that is to be consumed by a different terminal.

For clarity and convenience of the following description, assume that a mobile terminal mentioned in the following description includes at least one of the components shown in FIGS. 1A to 1C. For instance, assume that a mobile terminal according to the present invention includes the wireless communication unit 110, the camera 121, the microphone 122, the display unit 151, the audio output unit 152, the memory 170 and the controller 180.

After one mobile terminal has selected an e-book (electronic-book) content to be consumed by a different terminal, if the e-book content is activated in the different terminal, the present invention relates to interaction with the different terminal in which the e-book content is activated.

For clarity of the descriptions of the following embodiments, two mobile terminals shall be named a first terminal and a second terminal, respectively. Moreover, in order to avoid confusion, ‘first’ shall be prefixed to each component of the first terminal, while ‘second’ shall be prefixed to each component of the second terminal.

In the following description, a method of recommending an e-book content according to the present invention is explained in detail.

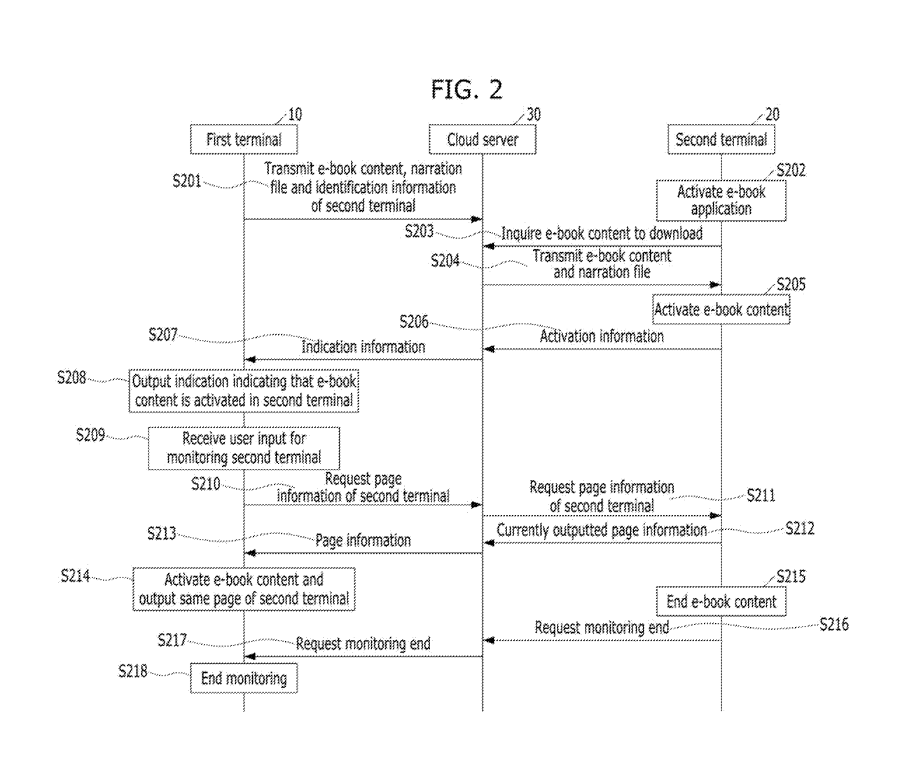

FIG. 2 is a flowchart for operations of a first mobile terminal and a second mobile terminal according to the present invention.

First of all, after an e-book content has been activated, if a user input for recording a narration for the e-book content is received, the first terminal is able to create a narration file for the e-book content by recording a user speech inputted through a first microphone [not shown in the drawing]. In this case, the narration may include the recording of such information, which is helpful in reading the e-book content, as reading sounds of words written in the e-book content, descriptions required for understanding the substance of the e-book content and the like.

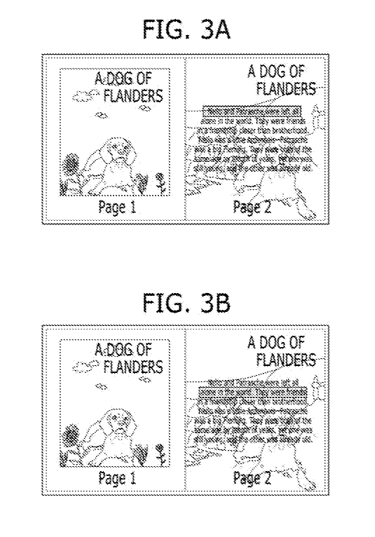

FIGS. 3A and 3B are diagrams of a user interface displayed on recording a narration.

Referring to FIGS. 3A and 3B, if a user input for recording a narration is received, a first controller records a user speech inputted through a first microphone and is able control a position of written words matched to the recorded speech to be visually identifiable. For instance, like the example shown in FIG. 3A, in case of intending to record a narration for Page 2 of an e-book content, the first controller controls a first line to be displayed in a manner of being visually identifiable, thereby informing a user that a narration for words on the first line needs to be recorded. After a lapse of a time, like the example shown in FIG. 3B, the first controller controls a second line to be displayed in a manner of being visually identifiable, thereby informing a user that a narration for words on the second line needs to be recorded. Although FIGS. 3A and 3B show one example that the narration recording proceeds by a line unit, the narration recording may be performed by a sentence unit.

Referring now to FIG. 2, the first terminal accesses an external server and is then able to transmit an e-book content to the external server [S201]. In doing so, if a narration file corresponding to the e-book content exists, the first controller can transmit the narration file to the external server together with the e-book content.

Moreover, the first terminal can transmit an identification information of the second terminal, which will consume the uploaded e-book content, to the external terminal. In this case, the identification information of the second terminal can include such an information for identifying the second terminal or a user of the second terminal as a phone number of the second terminal, an ID (identification), which is used when the second terminal accesses the external server, a name of a user of the second terminal, a social security number of the user of the second terminal, a photo of the user of the second terminal and the like. The external server can determined whether the second terminal has accessed the external server based on the identification information, which is received from the first terminal, on the second terminal.

In doing so, the external server plays a role as a cloud in receiving the e-book content from the first terminal, saving the received e-book content and transmitting the saved content to the second terminal and is also able to play a role as an exchanger for exchanging data for communications between the first terminal and the second terminal.

Once an e-book application is run in the second terminal [S202], the second terminal accesses the external server and is then able to inquire whether an e-book content saved for the second terminal is present using the identification information of the second terminal [S203]. If the e-book content saved for the second terminal is present, the second terminal can download the e-book content from the external server [S204]. In this case, if a narration file corresponding to the e-book content is present as well, the second terminal can download the narration file as well as the e-book content.

If a user selects the downloaded e-book content, the second controller can activate or play the downloaded e-book content [S205]. In doing so, if the narration file mapped to the downloaded e-book content is present, the second controller can play the narration file as soon as activate the e-book content.

When the narration file is played, the second controller can control a text string mapped to an outputted part to be displayed in a manner of being highlighted.

For instance, in the former example shown in FIG. 3A, if a narration for a first line of the e-book content is currently outputted, the second controller can control the first line to be highlighted and displayed.

After an elapse of a time, if a narration for a second line of the e-book content is outputted, the second controller may be able to control the second line to be highlighted and displayed.

If the downloaded e-book content is activated [S205], the second terminal can transmit an activation information, which indicates that the e-book content provided by the first terminal has been activated, to the external server [S206]. Having received the activation information, the external server can transmit an indication information, which indicates that the e-book content has been activated in the second terminal To the first terminal [S207].

Having received the indication information from the external server, the first terminal displays a notification, which indicates that the e-book application has been activated in the second terminal [S208], and is then able to determine whether to monitor the second terminal based on a user input [S209]. In doing so, the notification, which indicates that the e-book application has been activated in the second terminal, can have one of various configurations including a popup window, an indicator on a status display line, and the like.

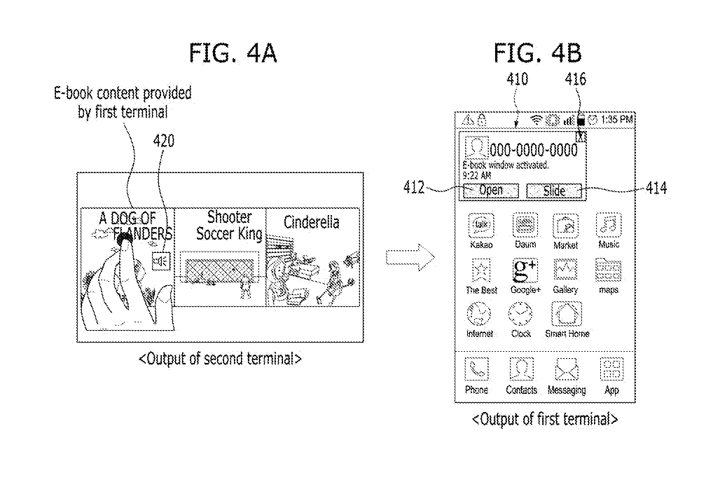

FIGS. 4A and 4B are diagrams for one example of a user interface provided to determine whether a first terminal having received an indication information to monitor a second terminal. In particular, FIG. 4A is a diagram for one example of an output of a second terminal and FIG. 4B is a diagram for one example of an output of a first terminal.

Referring to FIGS. 4A and 4B, if an e-book application is run, a second terminal downloads an e-book content, which was uploaded by a first terminal, from an external server and is then able to control a list of e-book contents saved in the second terminal to be displayed like the example shown in FIG. 4A. In doing so, a second controller can control an indicator 420, which indicates that a narration file is attached to an narration file attached e-book content, to be displayed on the e-book content list. For instance, referring to FIG. 4A, the indicator 420, which indicates that a narration file is attached, is outputted to a first e-book content on the e-book content list. Although the indicator 420 is configured as an icon in the example shown in FIG. 4A, it can be configured as a text as well.

If an e-book content provided by the first terminal is selected from the displayed e-book content list, the second terminal activates the e-book content and is also able to transmit an activation information, which indicates that the e-book content has been activated, to the external server.

Having received the activation information, the external server transmits an indication information. If the indication information is received, like the example shown in FIG. 4B, the first controller can control a popup window 410, which indicates that the e-book content is activated to be displayed on the first terminal. In this case, an identification information (e.g., a name of a user of the second terminal, a phone number of a user of the second terminal, etc.) of the second terminal, an information (e.g., a title of an e-book content, etc.) on an e-book content activated in the second terminal and the like may be included in the popup window 410.

In this case, a button for determining whether to monitor the second terminal can be included in the popup window 410.

For instance, in the popup window 410 shown in FIG. 4B, an open button 412 may be provided to configure a user interface for monitoring the second terminal with a full screen. For instance, in the popup window 410 shown in FIG. 4B, a slide button 414 may be provided to configure a user interface for monitoring the second terminal with a popup window. In particular, in the popup window 410 shown in FIG. 4B, if the open button 412 or the slide button 414 is touched, it can be determined the second terminal will be monitored.

If an end button 416 for ending the popup window is touched without a touch to the open button 412 or the slide button 414, the first controller can determine that the monitoring on the second terminal is held. If a user input to the popup window 410 is not received despite a lapse of a prescribed time, the first controller stops outputting the popup window 410 to the first display unit and is also able to hold the monitoring on the second terminal.

If the indication information indicating that the e-book content has been activated in the second terminal is received, the first controller can control an indicator, which indicates that the e-book content has been activated in the second terminal, to be outputted.

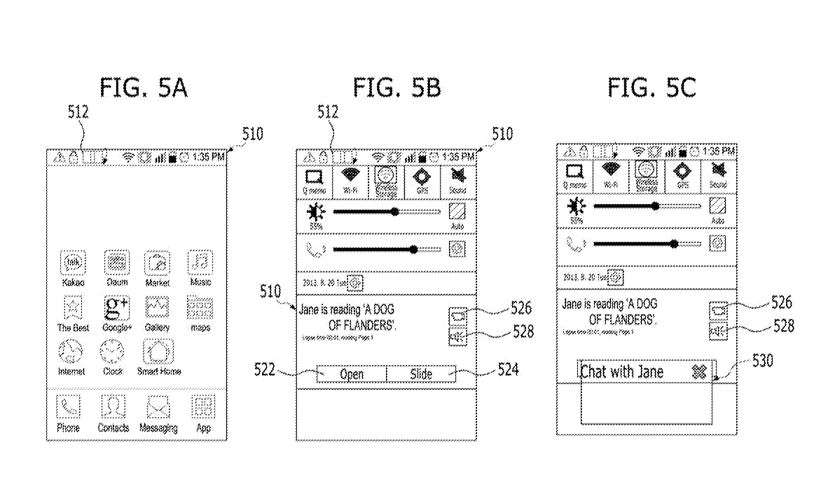

For instance, FIGS. 5A to 5C are diagrams for one example of outputting an indicator indicating that an e-book content has been activated in a second terminal.

Referring to FIGS. 5A to 5C, if an indication information indicating that an e-book content has been activated in a second terminal is received, like the example shown in FIG. 5A, a first controller can control an indicator 512, which indicates that the e-book content has been activated in the second terminal, to be displayed on a status display line 510 that displays information related to an operating status of a terminal. In doing so, if a user input of dragging to move a pointer currently touching the status display line 510 in a prescribed direction (e.g., a bottom direction) is received, like the example shown in FIG. 5B, the first controller can control an e-book content activation information 520 to be displayed.

In this case, the activation information 520 of the e-book content can include at least one of an identification information (e.g., a name of a user of the second terminal, a phone number of the user of the second terminal, etc.) of the second terminal, an information (e.g., a title of an e-book content, etc.) of an e-book content currently activated in the second terminal, a page of an e-book content currently outputted from the second terminal, a time having elapsed since activating an e-book content in the second terminal, and the like.

The first controller may be able to control buttons 522 and 524, which are provided to determine whether to monitor the second terminal, to be displayed together with the activation information 520 of the e-book content.

In doing so, if a user input of touching the activation information 520 of the e-book content is received, like the example shown in FIG. 5C, the first controller can control a chat window 530, which is provided to display a chat substance with the second terminal, to be displayed. If a user's speech is inputted or a chat substance to be sent to the second terminal is inputted through a keypad, the first controller sends a speech, a text converted from a speech by STT or a text inputted through the keypad to the second terminal and is also able to control the text converted from the speech by STT or the text inputted through the keypad to be displayed on the chat window 530.

Moreover, if speech data or text data is outputted from the second terminal, the first controller can control the text converted from the speech data by STT or the data inputted through the keypad to be displayed on the chat window 530.

While the chat window 530 is displayed, if a speech inputted by a user of the first terminal, a text converted from the speech by STT, or a text inputted through the keypad is sent to the second terminal, the second controller can control the text converted from the speech or the text inputted through the keypad to be displayed together with the e-book content [not shown in the drawing].

If the chat window 530 is activated in the first terminal or a chat substance (e.g., a speech, a text, etc.) inputted since activating the chat window 530 is transmitted to the second terminal, the second controller of the second terminal can control pause an output of a narration file. By pausing the output of the narration file, it is able to guide a user of the second terminal to concentrate on having a chat with a user of the first terminal Thereafter, if a user input for resuming a play of the narration file is received, the first controller can control a play to be resumed from a timing point of pausing the output of the narration file or a timing point ahead of the timing point of pausing the output of the narration file by a prescribed time.

The first controller can control at least one of an image icon 526 for obtaining an image data from the second terminal and an audio icon 528 for obtaining an audio data from the second terminal to be further displayed together with activation information of an e-book content.

If the image icon 526 is touched, the first controller can receive and output an image data inputted from a second camera of the second terminal. If the audio 528 is touched, the first controller can receive and output an audio data inputted from a second microphone of the second terminal. In addition, if the image icon 526 is touched, the first controller can provide an image inputted through the first camera to the second terminal. If the audio icon 528 is touched, the first controller can provide audio data inputted through the first microphone to the second terminal. In particular, it is able to perform interaction between the first terminal and the second terminal through the image icon 526 using images. And, it is able to perform interaction between the first terminal and the second terminal through the audio icon 528 using audio.

If the image icon 526 or the audio icon 528 is touched, the first controller can make a request for providing image data or audio data to the second terminal. If the user of the second terminal accepts the corresponding request, the first terminal can be provided with the image data or the audio data by the second terminal. For another instance, if the first terminal is authenticated by the second terminal in advance (e.g., as the first terminal and the second terminal are a parent's terminal and a child's terminal, respectively, an authority of a remote access to the second terminal has been already given to the first terminal), the first terminal can be provided with image data or audio data by the second terminal without a second terminal user's grant. If appreciation of an e-book content is ended in the second terminal, the first controller can control the indicator 512 to stop being displayed. The example for a case of ending the appreciation of the e-book content in the second terminal shall be described in detail later with reference to the step S215.

According to the examples shown in FIGS. 4A and 4B and FIGS. 5A to 5C, the user of the first terminal can determine whether to monitor the second terminal through the popup window 410 for determining whether to monitor the second terminal or manipulation on the buttons displayed together with the activation information of the e-book content. Yet, the user interfaces provided to a user to determine the monitoring are just examples for clarity of the descriptions, by which the present invention is non-limited. Moreover, a user interface different from the examples may be provided to each mobile terminal.

If it is determined to monitor the second terminal, the first controller can configure a user interface for monitoring the second terminal Through the user interface, a page identical to a prescribed page of an e-book content currently activated through the second terminal is outputted and at least one of an image data, an audio data and a text data received from the second terminal can be further outputted in addition.

In order to output the same page of the e-book content currently outputted through the second terminal, the first terminal can make a request for transmitting a page information of the e-book content currently outputted by the second terminal to the external server [S210]. Having received the request from the first terminal, the external server can make a request for providing a page information of the e-book content currently outputted by the second terminal to the second terminal [S211].

Having received the request made by the external server, the second terminal can transmit the currently outputted page information to the external server [S212]. If the external server transmits the page information received from the second terminal to the first terminal [S213], the first terminal activates the e-book content and is able to control a page identical to the page currently outputted by the second terminal to be outputted based on the received page information [S214].

If a page of the e-book content outputted through the second terminal is changed, the second controller transmits a changed page information to the external server so as to control the first terminal to output the same page as outputted by the second terminal.

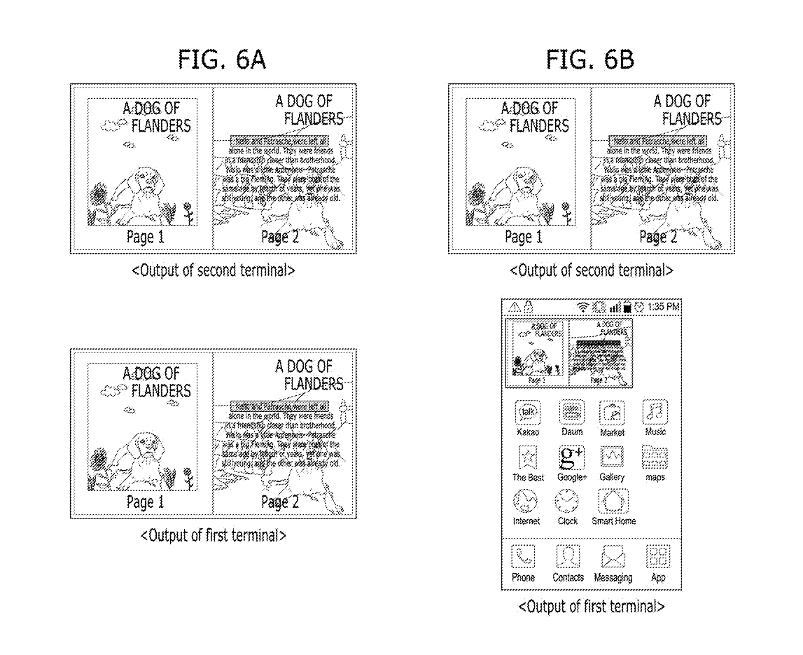

FIGS. 6A and 6B are diagrams for one example of a user interface outputting the same page of a second terminal.

Referring to FIGS. 6A and 6B, if an information on a page currently outputted by the second terminal is received from the external server, like the example shown in FIG. 6A, the first controller activates an e-book content and is able to control a page identical to the page currently outputted by the second terminal to be displayed through a full region of the first display unit 151.

For another instance, like the example shown in FIG. 6B, the first controller can control a page identical to a page currently outputted by the second terminal to be displayed through a popup window.

In doing so, the first controller may receive a position information on a part currently read by a second terminal user within the currently outputted part from the second terminal. If the position information is received, the first controller can control the part currently read by the second terminal user to be displayed in a manner of being emphasized. For instance, referring to FIG. 6A, if a position information indicating that the second terminal user is reading a part ‘Twinkle Twinkle Little Star’ is received, the first controller can control the corresponding text to be displayed in a manner of being highlighted.

In doing so, the second controller is able to obtain the information on the part currently read by the second terminal user by analyzing second terminal user eyes inputted through the camera. The second controller is able to obtain the information on the part currently read by the second terminal user by comparing a narration file to a speech of the second terminal user. For another instance, the second controller may determine that a part corresponding to an output of narration is the part currently read by the second terminal user.

If the part currently read by the second terminal user is displayed in a manner of being highlighted, the first terminal user can estimate a position currently read by the second terminal user, a sound reading speed of the second terminal user and the like.

Image or text data received together with page information can be outputted in a manner of overlaying an e-book content or through another space region failing to overlap the e-book content.

Examples of outputting image data, audio data, text data and the like as well as an e-book content are described in detail with reference to the following drawings.

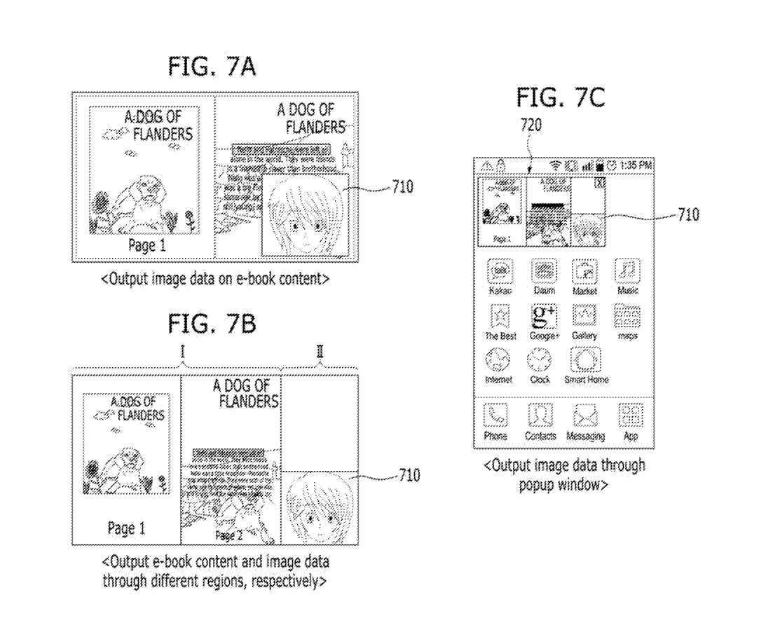

FIGS. 7A to 7C are diagrams for one example of an output of a user interface including image data.

Referring to FIGS. 7A to 7C, if an output of image data inputted to the second camera of the second terminal is requested by a user, the first terminal can make a request for providing an image inputted through the camera of the second terminal to the external server. If the external server makes a request for providing an image inputted through the second camera to the second terminal, the second controller encodes the image inputted through the second camera and is then able to provide the encoded image to the external server.

Thereafter, the external server transmits image data received from the second terminal to the first terminal. The first controller is then able to decode and output the received image data.

Like the example shown in FIG. 7A, the first controller can control the received image data 710 to be displayed on the e-book content. Yet, in this case, the image data may block a prescribed portion of the e-book content. To prevent this, the image data 710 may be semi-transparently displayed on the e-book content. The transparency level of the image data 710 can be manually adjusted by a user.

For another instance, like the example shown in FIG. 7B, the first controller can control the e-book content and the received image data 710 to be displayed through two regions I and II failing to overlap each other on the first display unit, respectively.

For another instance, like the example shown in FIG. 7C, the first controller can control the e-book content and the image data 710 of the second terminal to be displayed through a popup window 720.

In case that the second terminal is provided with a front camera and a rear camera, an image data to be provided to the first terminal may be created through the front camera of the second terminal. This is to provide an image of photographing a user currently reading the e-book content by watching the second display unit to the second terminal.

The second terminal can provide the first terminal with an audio data inputted through the second microphone [not shown in the drawing]. The first terminal outputs the received image data and the received audio data at the same time, thereby enabling a user of the first terminal to check an appearance and vocal sound of the second terminal user currently reading the e-book content.

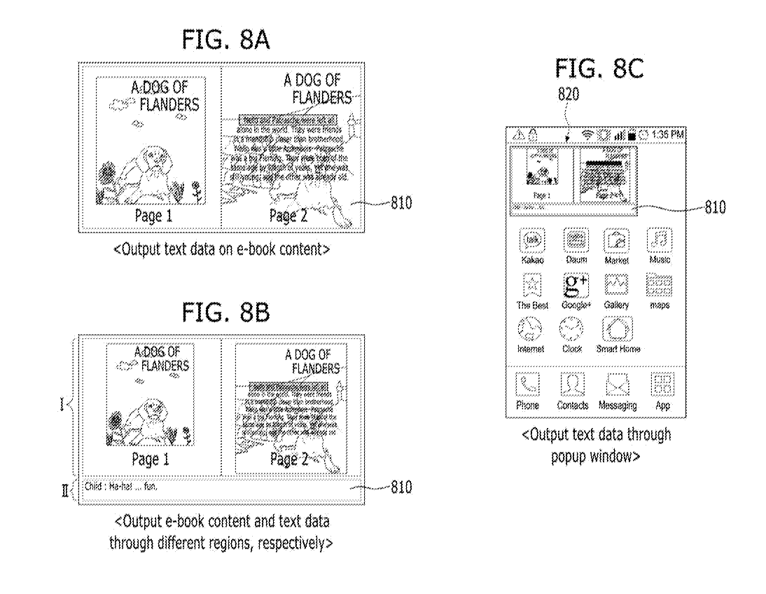

FIGS. 8A to 8C are diagrams for one example of an output of a user interface including text data.

Referring to FIGS. 8A to 8C, if a user makes a request for an output of a text data 810 created by converting an audio data inputted through the second microphone of the second terminal to a text, the first terminal can make a request for providing the audio data inputted through the second microphone of the second terminal or the text data 810 created by converting the audio data by STT (speech to text) to the external terminal. If the external server makes a request for providing the audio data or the text data 810 to the second terminal, the second controller can provide the external server with the audio data inputted through the second microphone or the text data 810 created by converting the audio data to a text.

Thereafter, the external server is able to transmit the audio data or the text data 810 received from the second terminal to the first terminal. The first controller is then able to output the received audio data by STT conversion or the received text data 810.

Like the example shown in FIG. 8A, the first controller can control the text data 810, which is created by converting the audio data to the text, to be displayed on the e-book content. Yet, in this case, the text data 810 may block a portion of the e-book content. To prevent this, like the example shown in FIG. 8B, the first controller can control the e-book content and the text data 810 to be outputted through two regions failing to overlap each other on the first display unit.

The first controller may be able to simultaneously output at least two of an image data, an audio data and a text data. In doing so, the first controller may control both of the audio data and the text data to be simultaneously outputted. Alternatively, the first controller may output either the audio data or the text data in accordance with a status of the first terminal.

For instance, if the first terminal is in audio output mode or an audio device such as an earphone and the like is connected to the first terminal, the first controller can control an audio data to be outputted. On the other hand, if the first terminal is in vibration mode and an audio device such as an earphone and the like is not connected to the first terminal, the first controller can control a text data, which is created by converting the audio data by STT conversion, to be outputted instead of the audio data.

According to the example shown in FIGS. 8A to 8C, a text data is created by converting an audio inputted through the second microphone by STT conversion. On the other hand, the text data may be inputted through the keypad of the second terminal.

According to the foregoing description of the embodiment, at least one of image data, audio data and text data inputted through the second terminal is transmitted to the first terminal. In addition, at least one of image data, audio data and text data inputted through the first terminal can be transmitted to the second terminal. The second controller of the second terminal outputs the image data received from the first terminal, the audio data received from the first terminal, the text data received from the first terminal and the like so that the second terminal user can watch an image of the first terminal user or listen to a speech of the first terminal user. In case that an image data inputted through the first camera is provided to the second terminal, the first controller can control the image data inputted through the first camera to be displayed on the first display unit in order to check whether an image inputted through the first camera is correctly taken. Hence, the first terminal user can check both an appearance of the first terminal user and an appearance of the second terminal user simultaneously through two image data (i.e., the image data inputted through the first camera and the image data received from the second terminal) displayed on the first display unit. The second controller of the second terminal can control an image inputted through the second camera and the image received from the first terminal to be simultaneously displayed on the second display unit in order to check whether the image inputted through the second camera is correctly taken.

Using the image data and audio data inputted through the second terminal, the first terminal may be able to output information on an emotional state of the second terminal user. The first terminal can determine the emotional state of the second terminal user by analyzing the image and audio data received from the second terminal. If the second terminal determines the emotional state of the second terminal user by analyzing the image data and the audio data, the first terminal can receive the emotional state information of the second terminal user from the second terminal.

In particular, the first controller or the second controller can determine a user's emotional state by considering a user's expression taken through the second camera, a user's voice recorded through the second microphone and the like. For instance, if a user has a smile expression, the first controller or the second controller can determine that the second terminal user has a happy emotion. If a user has a frowning expression, the first controller or the second controller can determine that the second terminal user has an irritated or angry emotion. Moreover, if a user's laughing sound is inputted, the first controller or the second controller can determine that the user is in happy or pleasant state. If a trembling voice of a user is detected, the first controller or the second controller can determine that the user is in sad or angry state.

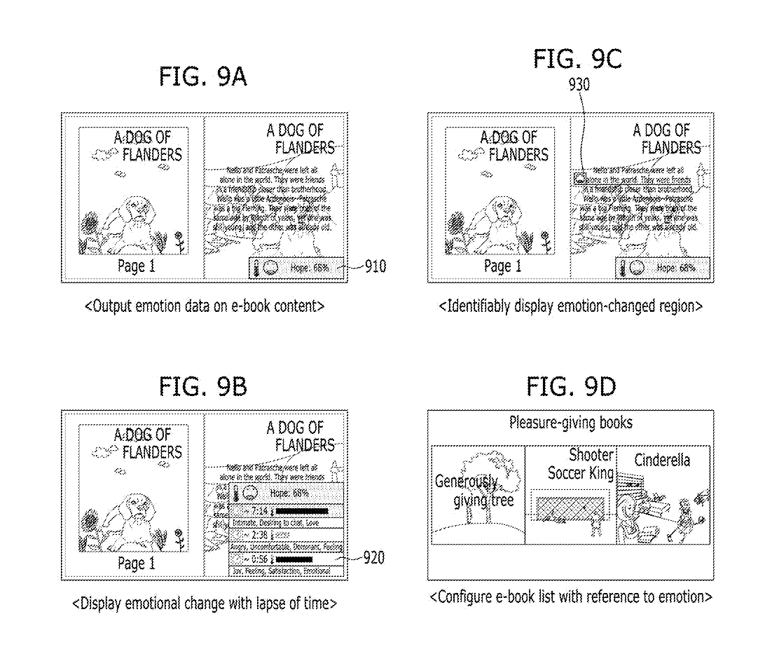

FIGS. 9A to 9D are diagrams for one example of an output of a user interface including emotional state information.

Referring to FIGS. 9A to 9D, a second terminal user's emotion information 910 created by analyzing image data and audio data can be displayed on an e-book content [FIG. 9A].

Besides, the controller may control an e-book content and an emotion information to be displayed through different regions failing to overlap each other on the first display unit or may control the emotion information to be outputted through a popup window including both of the e-book content and the emotion information.

The first controller accumulates and saves emotion information of the second terminal user and is able to output an emotional change of the second terminal user with the lapse of time. For instance, like the example shown in FIG. 9B, the first controller can control a table 920, in which a user's emotional state per time slot is schematized, to be displayed.

The first controller can control a part corresponding to an emotional change of the second terminal user to be displayed on the e-book content in a manner of being visually identifiable. For instance, in the example shown in FIG. 9C, while the second terminal user is in calm state, if an emotional state of the second terminal user is changed into a pleasant state when reading a sentence ‘How I wonder what you are’, like the example shown in FIG. 9C, the first controller can display that the emotional state of the second terminal user is changed in the corresponding sentence. According to the example shown in FIG. 9C, the corresponding sentence is underlined and an indicator 930 indicating the changed emotional state of the second terminal user is displayed nearby the corresponding sentence.

The first terminal may be able to output a list of e-book contents, from which the second terminal user feels prescribed emotion, among at least one or more e-book contents read by the second terminal user. For instance, if a user input of making a request for providing a list of e-book contents, from which the second terminal user feels pleasure, is received, like the example shown in FIG. 9D, the first controller can display a list of e-book contents from which the second terminal user feels pleasure in the course of reading the corresponding e-book contents.

In doing so, the first controller can configure a list of e-book contents, from which the second terminal user feels prescribed emotion, based on a result from cumulatively saving the emotional changes of the second terminal user. The first controller can receive a list of e-book contents, from which the second terminal user feels prescribed emotion, from the external server or the second terminal.

The first terminal can display information on a second terminal user's sound reading capability, which is created from analyzing audio data inputted through the second microphone. To this end, the first controller or the second controller can determine the second terminal user's sound reading capability by analyzing the audio data inputted through the second microphone. The first controller or the second controller can estimate pronunciation, speed, intonation, accuracy and the like in consideration of a voice tone inputted through a microphone, accuracy of pronunciation, sound reading speed and the like.

The first controller or the second controller may be able to estimate a second terminal user's sound reading capability by comparing a second terminal user's voice inputted through a microphone to a narration recorded by the first terminal user.

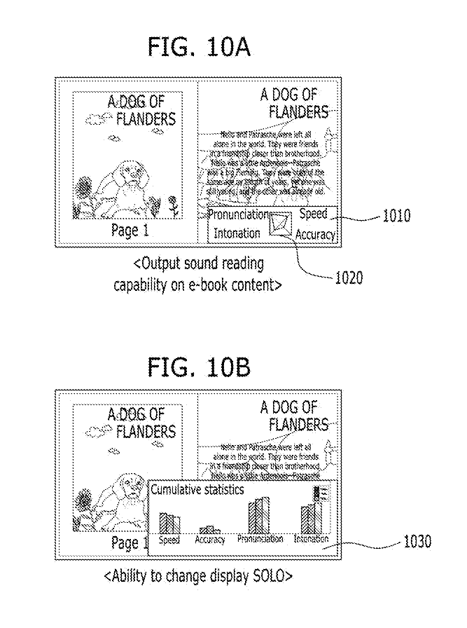

FIGS. 10A and 10B are diagrams for one example of an output of a user interface including voice-reading capability information.

Referring to FIGS. 10A and 10B, a second terminal user's sound reading capability information 1010 created from analyzing audio data can be displayed on a real-time output screen of the second terminal [FIG. 10A]. In doing so, after a polygon 1020 has been drawn in a manner that each estimated item is located at q corresponding vertex, the first controller can express an estimated value for each estimated item by schematizing a distance between the vertexes centering on a center of the polygon 1020.

Moreover, the first controller can control a real-time output screen and an estimated data to be outputted through different regions failing to overlap each other on the first display unit, respectively or can control the estimated data to be outputted through a popup window including both of the real-time output screen and the estimated data [not shown in the drawing].

The first controller cumulatively save the second terminal user's sound reading capability information and is able to output a change of the second terminal user's sound reading capability. For instance, like the example shown in FIG. 10B, the first controller can control a graph 1030, which shows the second terminal user's sound reading capability changes with the lapse of time, to be displayed.

While an e-book content is used, if the second terminal user inputs a question, which is to be sent to the first terminal, through the second microphone, the second terminal can transmit an audio data transmitted through the second microphone or a text data STT-converted from the audio data to the first terminal. In doing so, while a narration file corresponding to the e-book content is outputted, if a user input for inputting the question is received from the second terminal user, the second controller can control the narration file to be paused.

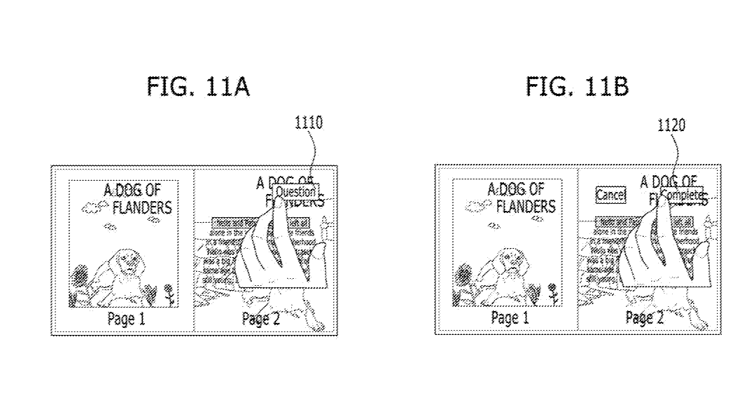

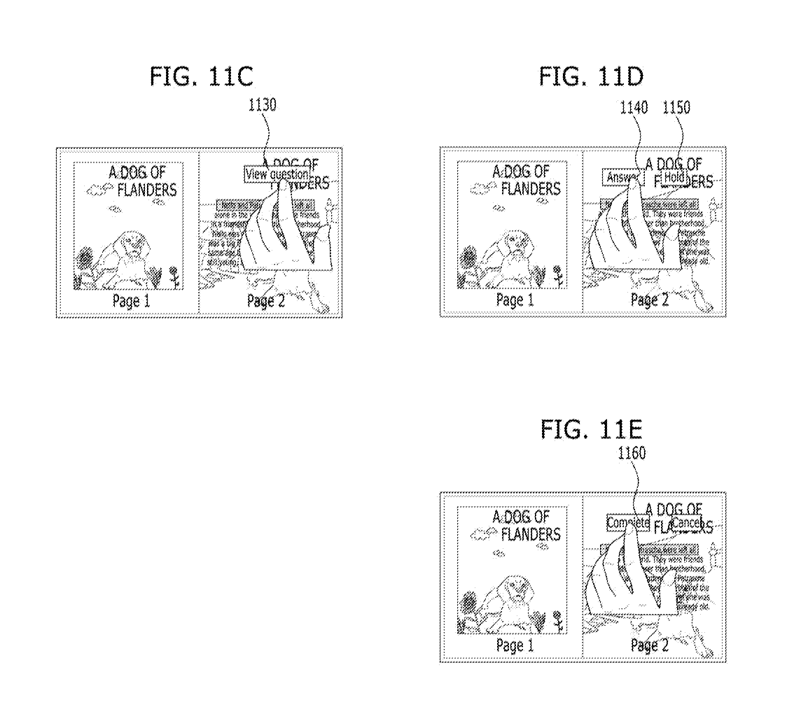

For instance, FIG. 11A to FIG. 11E are diagrams of a user interface provided to a second terminal to input a question and a user interface provided to a first terminal receiving an input of a question, respectively.

Referring to FIGS. 11A and 11B, if an e-book content is activated, like the example shown in FIG. 11A, the second controller can control a ‘question’ button 1110, which is provided to receive an input of a question from the second terminal user, to be displayed. If the ‘question’ button 1110 shown in FIG. 11A is touched, the second controller can receive an input of a user's speech through the second microphone. In doing so, if a narration file corresponding to the e-book content is being outputted, the second controller can stop outputting the narration while the question is inputted.

Subsequently, if a ‘complete’ button 1120 shown in FIG. 11B is touched, the second controller can transmit the audio data inputted through the microphone or a text data STT-converted from the audio data inputted through the second microphone to the first terminal. Simultaneously, the second controller can resume the output of the paused narration file.

According to the example shown in FIGS. 11A and 11B, by touching the ‘question’ button, the second terminal user can input the question. For another example, the second controller can determine whether the second terminal user has inputted a question through a natural language analysis of audio data inputted through the second microphone. For instance, as a result from analyzing a natural language inputted through the second microphone, if an inputted audio is determined as a question about the first terminal user, the second controller can transmit the audio data inputted through the second microphone or the text data STT-converted from the audio data inputted through the second microphone to the first terminal.

Having received the audio data or the text data from the second terminal, like the example shown in FIG. 11C, the first controller can output an object (e.g., ‘view question’ button) indicating that the question has been received from the second terminal.

If the ‘view question’ button 1130 shown in FIG. 11C is touched, the first controller outputs the audio or text data received from the second terminal so that a user can check the question inputted by the second terminal user.

Subsequently, if a ‘answer’ button 1140 shown in FIG. 11D is touched, the first controller can receive an input of audio data inputted through the first microphone.

Thereafter, if a ‘complete’ button 1160 shown in FIG. 11E is touched, the first controller can transmit the audio data inputted through the first microphone or the text data STT-converted from the audio data inputted through the first microphone to the second terminal.

The second controller of the second terminal outputs the audio or text data received from the first terminal so as to output a first terminal user's answer to the luestion inputted by the second terminal user.

In doing so, while the answer data received from the first terminal is outputted, the second controller may be able to control an output of a narration file to be paused. Once the output of the answer data received from the first terminal is complete, the second controller can control the play to be resumed from a timing point of pausing the output of the narration file or a timing point ahead of the timing point of pausing the output of the narration file by a prescribed time.

If a ‘hold’ button 1150 shown in FIG. 11D is touched, the first controller can transmit an indication information, which indicates that the first terminal user is in a state of being unable to answer the question, to the second terminal. If the indication information is received from the first terminal, the second controller can control an audio or message, which indicates that the first terminal user is unable to answer the question, to be outputted.

After the answer to the second terminal user's question has been held, if the answer to the second terminal user's question is inputted through the first terminal, the first controller can transmit data for the inputted answer to the second terminal.

If the data for the answer is received from the first terminal, the second controller output an indicator indicating that the data for the answer has been received and is also able to output the data received from the first terminal.

According to the example shown in FIGS. 11A and 11B, if the ‘question’ button is touched, the second terminal user is able to input a question through a speech. Unlike the above-described example, if the ‘question’ button is touched, the second controller may be able to display a keypad to enable a user to input a text. The second terminal user can input a question to ask the first terminal user through the keypad.

Moreover, the first terminal user can compose the answer to the question received through a keypad. To this end, if an ‘answer’ button is touched, the first controller can control a keypad for inputting an answer to the question to be displayed.

According to the example shown in FIGS. 11C to 11E, only if the ‘answer’ button is touched, the first terminal user is able to input the answer to the second terminal user's question. Unlike the above-description of the example, if an output of audio or text data received from the second terminal is complete, the first controller may be able to control the first microphone to maintain an active state during a prescribed time. As an audio data inputted in the course of maintaining the active state is regarded as an answer to a second terminal user's question, the inputted audio data or a text data converted from the audio data can be transmitted to the second terminal. In doing so, in order to indicate a state that a user can input an answer owing to the first microphone in active state, the first controller can control an indicator, which indicates that the first microphone is currently active, to be displayed.

In addition, if an answer is not inputted despite the elapse of a prescribed time since activation of the first microphone, the first controller determines a state that the first terminal user is unable to input the answer and may be then able to transmit an indication information, which indicates that the first terminal user is in the state of being unable to answer the question, to the second terminal.

According to the example shown in FIGS. 11C to 11E, as a response to the second terminal user's question, an audio data of the first terminal user or a text data created from converting a speech of the first terminal user to a text is transmitted to the second terminal.

As an answer to a second terminal user's question, the first controller may receive an input of such a multimedia file, which can be utilized as an answer to a question, as an image, a document and the like. In case that an image or a document is attached as an answer to a second terminal user's question, the first controller may be able to transmit the attached file to the second terminal.

If a file is received as an answer to a question from the first terminal, the second controller can output the received file.

According to the examples shown in FIGS. 11A to 11E, while the first terminal is monitoring the second terminal, a question and an answer can be exchanged between the first terminal and the second terminal. For another example, although the first terminal is not monitoring the second terminal, the first terminal can receive a question from the second terminal and answer the received question.

Moreover, according to the example shown in FIGS. 11C to 11E, if the first terminal receives a question from the second terminal, the ‘answer’ button is displayed to indicate that the question was received from the second terminal. For another example, if a question is received from the second terminal, the first controller can indicate that the question was received from the second terminal by displaying an indicator indicating that the question was received from the second terminal on a status display line or the like.

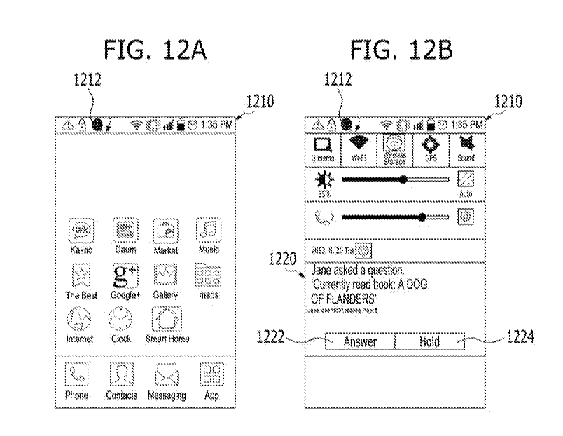

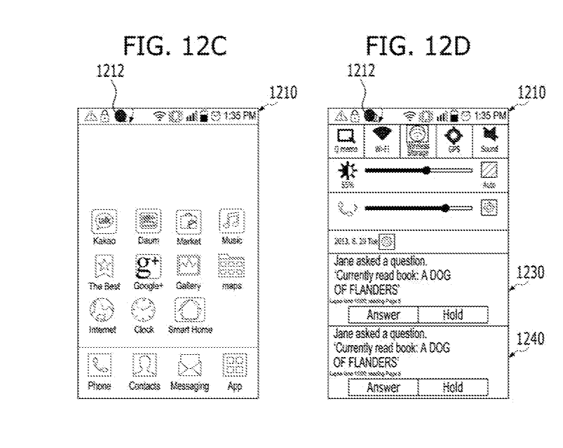

For instance, FIGS. 12A to 12D are diagrams for examples of displaying an indicator indicating that a question is received from a second terminal.

Referring to FIGS. 12A and 12B, if a question is received from the second terminal, the first controller can control an indicator 1212, which indicates that the question was received from the second terminal, to be displayed on a status display line 1210. According to the example shown in FIG. 12A, the indicator 121 is displayed on the status display line 1210.

In doing so, if a user input of dragging to move a pointer currently touching the status display line 1210 in a prescribed direction is received, like the example shown in FIG. 12B, the first controller can control an information 1220 on the received question to be displayed.

In this case, the information 1220 on the received question may include at least one of an identification information (e.g., a name of the second terminal user, a phone number of the second terminal user, etc.) of the second terminal, an information (e.g., a title of an e-book content) of the e-book content currently activated in the second terminal, and a question content.

If the question information 1220 is touched, the first controller can control the question to be outputted.

The first controller may be able to display a button 1222 for answering the received question together with the question information 1220. In the example shown in FIG. 12B, if the ‘answer’ button 1222 is touched, the first controller receives an input of an answer to the question through the first microphone or the keypad and is then able to transmit the inputted answer content to the second terminal.

In the example shown in FIG. 12B, if a ‘hold’ button 1224 is touched, the first controller may be able to transmit an indication information, which indicates that the first terminal user is in a state of being unable to answer the question, to the second terminal.

In case that a plurality of questions are received from the second terminal, the first controller can display an indicator 1212 which indicates the number of the received questions. For instance, in case that two questions are received from the second terminal, like the example shown in FIG. 12C, the first controller can control an indicator 1212, which indicates the reception of the questions and the number of the questions received from the second terminal, to be displayed. According to the example shown in FIG. 12C, a text string ‘x2’ indicating that the number of the received questions is 2 is displayed on the indicator 1212.

In doing so, if a user input of dragging to move a pointer currently touching the status display line 1210 in a prescribed direction is received, like the example shown in FIG. 12D, the first controller can control question information 1230 and 1240 on the questions to be displayed.

The first terminal user may be able to answer each of the questions through an ‘answer’ button provided together with the corresponding question information.

Referring now to FIG. 2, if the appreciation of the e-book content is ended in the second terminal [S215], the second controller can make a request for ending the monitoring of the end terminal to the external server [S216]. Having received request from the second terminal, the external server makes a request for ending the monitoring to the first terminal [S217]. Having received the request from the external server, the first controller of the first terminal can end the monitoring of the second terminal [S218]. As soon as the monitoring is ended, the e-book content can be ended in the first terminal and the output of the video, audio and/or text data received from the second terminal can be ended as well.

In doing so, in case of receiving a user's touch input to ending the e-book content, a user's speech content for ending the e-book content, or the like, the second controller can end the e-book content. For another instance, if the second terminal user is not detected over prescribed duration through the second camera (e.g., the front camera of the second terminal, etc.), the second controller can end the e-book content.

Once the appreciation of the e-book content is ended in the second terminal, the first controller may be able to control an indicator, which indicates that the appreciation of the e-book content was ended in the second terminal, to be outputted.

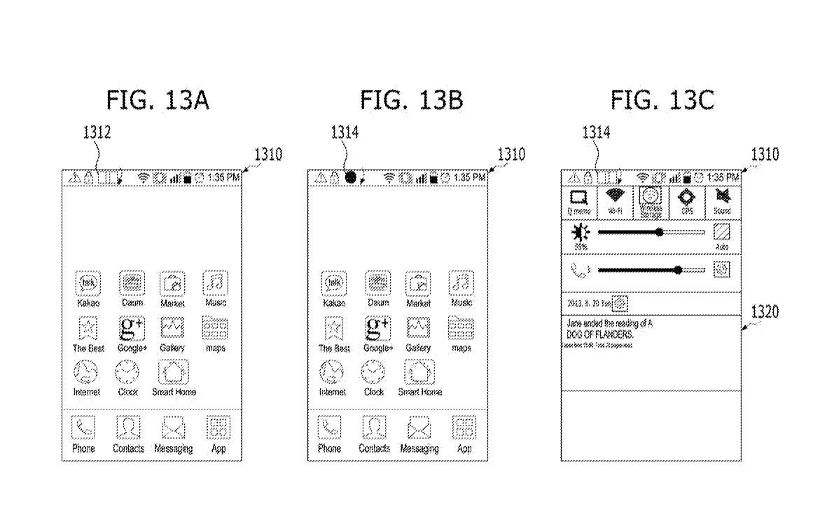

For instance, FIGS. 13A and 13B are diagrams for one example of outputting an indicator indicating that appreciation of an e-book content is ended in a second terminal.

Referring to FIGS. 13A and 13B, if an e-book content is activated in the second terminal as mentioned in the foregoing description with reference to FIGS. 5A to 5C, the controller can control a first indicator 1312, which indicates that the e-book content has been activated in the second terminal, to be displayed [FIG. 13A]. Thereafter, if the e-book content is ended in the second terminal, the first controller stops displaying the first indicator 1312 and is able to control a second indicator 1314, which indicates that the e-book content was ended in the second terminal, to be displayed [FIG. 13B].

According to the examples shown in FIG. 13A and FIG. 13B, the first indicator 1312 and the second indicator 1314 are displayed on a status display line 1310.

In doing so, if a drag input of moving a pointer currently touching the status display line 1310 in a prescribed direction is received, like the example shown in FIG. 13C, the first controller can control an end information 1320 to be displayed. In this case, the end information 1320 may include at least one of an identification information of the second terminal, an information of the e-book content ended in the second terminal, an appreciated time of the e-book content ended in the second terminal, and the like.

If the end information 1320 is touched or a prescribed time expires, the first controller can stop outputting the second indicator 1314.

According to the example shown in FIG. 2, in order to monitor the second terminal, the first terminal receives the page information of the e-book content currently outputted from the second terminal Unlike the foregoing description of the embodiment, the first terminal may be able to receive a real-time output screen of the second terminal from the second terminal. In case of receiving to output the real-time output screen of the second terminal, although a page of the e-book content currently activated through the second terminal is changed, it may be able to monitor the second terminal without receiving the information of the changed page.

Moreover, according to the example shown in FIG. 2, the first terminal and the second terminal communicate with each other via the external server. Unlike the illustrated example, the first terminal and the second terminal can directly communicate with each other by Wi-Fi Direct, Bluetooth, NFC or the like. In this case, the first terminal may be able to directly transmit an e-book content and a narration file corresponding to the e-book content to the second terminal.

According to the example shown in FIG. 2, through communications with the external server, the first terminal and the second terminal upload/download an e-book content or the monitoring of the second terminal is performed. Unlike the example, the first terminal and the second terminal can be configured to upload/download an e-book content through communications with a first server and the monitoring of the second terminal can be performed through communications with a second server different from the first server.

According to the embodiments mentioned in the foregoing descriptions, the first terminal provides an e-book content to the second terminal and is able to monitor a second terminal user currently appreciating the e-book content from different angles. If a user of the first terminal is a parent and a user of the second terminal is a child, the parent can recommend an e-book content to be read by the child and is able to monitor the child who is reading the e-book content.

Accordingly, embodiments of the present invention provide various effects and/or features.

First of all, the present invention provides a mobile terminal and controlling method thereof, by which user's convenience can be further enhanced.

In particular, the present invention provides a mobile terminal and controlling method thereof, by which an e-book content appropriate for a prescribed terminal user can be recommended.

And, the present invention provides a mobile terminal and controlling method thereof, by which interaction with a prescribed terminal user currently appreciating an e-book content can be performed.

It will be appreciated by those skilled in the art that the present invention can be specified into other form(s) without departing from the spirit or scope of the inventions.

In addition, the above-described methods can be implemented in a program recorded medium as processor-readable codes. The processor-readable media may include all kinds of recording devices in which data readable by a processor are stored. The processor-readable media may include ROM, RAM, CD-ROM, magnetic tapes, floppy discs, optical data storage devices, and the like for example and also include carrier-wave type implementations (e.g., transmission via Internet).

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A mobile terminal comprising:
a memory configured to store an e-book;
a wireless communication unit configured to communicate with at least an external server or a second terminal;
an audio output unit configured to output audio data;
a display configured to display contents of the e-book; and
a controller configured to:
cause the wireless communication unit to transmit at least partial content of the e-book to at least the external server or the second terminal;
cause the display to display a first notification notifying that the e-book or the at least partial content of the e-book is activated in the second terminal;
cause the display to display content of the e-book in response to an input received in response to the displayed notification; and
cause output or display of at least an image, an audio, or a text received from the second terminal in which the e-book is activated via the audio output unit or the display.

2. The mobile terminal of claim 1, wherein the image, audio, and text are input via an input unit the second terminal.

3. The mobile terminal of claim 2, wherein the image is semi-transparently displayed.

4. The mobile terminal of claim 2, further comprising a camera configured to obtain an image, wherein the controller is further configured to cause the wireless communication unit to transmit the image obtained via the camera to the second terminal while the content of the e-book and the image received from the second terminal are displayed.

5. The mobile terminal of claim 2, wherein the controller is further configured to:
cause the audio output unit to output the audio received from the second terminal while the one content of the e-book is displayed; or
cause the display to display text data converted from the audio to be outputted while the content of the e-book is displayed, the text data generated by speech to text (STT) conversion.

6. The mobile terminal of claim 1, wherein the controller is further configured to cause the display to display an indicator indicating that at least the image, the audio, or the text is received from the second terminal while the content of the e-book is displayed.

7. The mobile terminal of claim 6, wherein the controller is further configured to cause the wireless communication unit to transmit audio data input via a microphone of the terminal or text data converted from the audio data via speech to text (STT) conversion to the second terminal while the content of the e-book is displayed.

8. The mobile terminal of claim 1, wherein the controller is further configured to cause the wireless communication unit to transmit a narration file attached to the e-book to at least the external server or the second terminal.

9. The mobile terminal of claim 1, wherein the controller is further configured to cause the display to display a page or content of the e-book that is currently displayed at the second terminal.

10. The mobile terminal of claim 9, wherein the controller is further configured to cause the display to indicate a portion of the page or content of the e-book that is currently read by a user of the second terminal, the portion displayed distinguishably from the rest of the displayed page or content.

11. The mobile terminal of claim 9, wherein the controller is further configured to cause the display to display the page or content of the e-book that is currently displayed at the second terminal at a first location of the display while at least one application icon or an execution screen of an application that is not related to the e-book is displayed at a second location of the display that is different from the first location.

12. The mobile terminal of claim 11, wherein the first location of the display is a popup window.

13. The mobile terminal of claim 1, wherein the first notification comprises at least an identifier of the second terminal and information related to the e-book activated at the second terminal, the information comprising at least a title of the activated e-book, a page or passage of the activated e-book currently displayed at the second terminal, or time elapsed since the activation of the e-book at the second terminal.

14. The mobile terminal of claim 1, wherein the controller is further configured to cause the display to display a second notification notifying completion of reading of the e-book at the second terminal.

15. The mobile terminal of claim 14, wherein the controller is further configured to cause the display to display an indicator indicating whether the e-book is being read or the reading of the e-book is completed at the second terminal.

16. The mobile terminal of claim 15, wherein the controller is further configured to cause the display to:
change an image of the indicator from a first image to a second image when the reading of the e-book is completed at the second terminal; and
display the second notification in response to selection of the indicator displayed as the second image.

17. A mobile terminal comprising:
a display configured to display information;
a wireless communication unit configured to communicate with at least an external server or a second terminal; and
a controller configured to:
cause the wireless communication unit to transmit a notification to at least the external server or the second terminal when an e-book originated from the second terminal and received from the external server or the second terminal is activated, the notification notifying the activation of the e-book at the mobile terminal;
cause the display to display content of the received e-book; and
cause the wireless communication unit to transmit or receive at least an image, an audio, or a text input via an input unit of the mobile terminal or the second terminal while the e-book is in an activated status.

18. The mobile terminal of claim 17, further comprising an audio output unit, wherein the controller is further configured to cause the audio output unit to output narration in response to activation of a narration file attached to the e-book.

19. The mobile terminal of claim 17, wherein the controller is further configured to cause the audio output unit to stop or pause the output of the narration when at least the image, the audio, or the text is received while the narration is output.

20. A method of controlling a mobile terminal, comprising:
transmitting, via a wireless communication unit, at least partial content of the e-book stored in a memory of the mobile terminal to at least an external server or a second terminal;
displaying, on a display, a notification notifying that the e-book or the at least partial content of the e-book is activated in the second terminal;
displaying, on the display, content of the e-book in response to an input received in response to the displayed notification; and
outputting or displaying, via an audio output unit or the display, at least an image, an audio, or a text received from the second terminal in which the e-book is activated while the content of the e-book is displayed.
